(19) United States
(12) Patent Application Publication
(10) Pub. No.: US 2022/0082074 A1
(43) Pub. Date: Mar. 17, 2022

(54) IGNITION UNIT AND MOTORIZED PRODUCT

(71) Applicant: PUNCH POWERTRAIN FRANCE, Clermont-Ferrand (FR)

(72) Inventors: Paul TINWELL, Clermont-Ferrand (FR); Thomas CHARLES, Clermont-Ferrand (FR); Alexandre KERMORVANT, Cerny (FR)

(21) Appl. No.: 17/299,865

(22) PCT Filed: Dec. 4, 2019
(86) PCT No.: PCT/EP2019/083752

§ 371 Date: Jun. 4, 2021

(30) Foreign Application Priority Data
Dec. 4, 2018 (EP) 18306615.8

(51) Int. Cl. F02P 3/02; F02P 23/04

(52) U.S. Cl. CPC F02P 3/02; F02P 23/045

(57) ABSTRACT

An ignition unit producing an ignition in a combustion chamber includes an electrode that has a tip section that is exposed to the combustion chamber when the ignition unit is fitted on a combustion engine. The electrode forms part of a microwave resonating structure that radiates a microwave field into the combustion chamber when a microwave excitation signal is applied to the electrode. A winding is electrically coupled to the electrode. The winding and the electrode form part of a radiofrequency resonator that radiates a radiofrequency field into the combustion chamber when a radiofrequency excitation signal is applied to the winding. A microwave signal path transfers the microwave excitation signal from a signal input connector on the ignition unit to the electrode. The microwave signal path includes an inductive portion and a capacitive coupling structure adapted to provide a capacitive coupling from the inductive portion to the electrode.

### CROSS-REFERENCE TO RELATED APPLICATION(S)

This is a National Stage Entry into the United States Patent and Trademark Office from International Patent Application No. PCT/EP2019/083752, filed on Dec. 4, 2019, which claims priority to European Patent Application No. 18306615.8, filed on Dec. 4, 2018; the entire contents of both of which are incorporated herein by reference.

### FIELD OF THE INVENTION

An aspect of the invention relates to an ignition unit that can produce an ignition in a combustion chamber of a combustion engine. The ignition unit may have an external shape that is similar to a conventional sparkplug. The ignition unit may thus be fitted in a combustion engine as if this unit were a conventional sparkplug. The ignition unit may also be applied to, for example, turbine engines. Another aspect of the invention relate to a motorized product comprising a combustion engine on which an ignition unit has been fitted.

### BACKGROUND OF THE INVENTION

Patent publication WO 2016/012448 discloses an ignition unit that produces an ignition in a combustion chamber of a combustion engine in the following manner. The ignition unit comprises a radio frequency resonator that radiates a plasma-creating radiofrequency field into the combustion chamber. The ignition unit further comprises a microwave resonator that radiates a plasma-boosting microwave field into the combustion chamber. In an embodiment, the microwave resonator has an output surface to which the combustion chamber is exposed when the ignition unit is fitted on the combustion engine. The radio frequency resonator may comprise an electrode that is at least partially embedded in the microwave resonator. The electrode may have a tip that is located at a distance from the output surface so that the microwave resonator provides a barrier between the tip and the output surface.

### SUMMARY OF THE INVENTION

There is a need for an improved solution that allows even greater efficiency in creating and boosting plasma in a combustion chamber using radiofrequency and microwave energy.

In accordance with an aspect of the invention as defined in claim 1, there is provided an ignition unit adapted to produce an ignition in a combustion chamber of a combustion engine, the ignition unit comprising:

an electrode that has a tip section adapted to be exposed to the combustion chamber when the ignition unit is fitted on the combustion engine, the electrode forming part of a microwave resonating structure adapted to radiate a microwave field into the combustion chamber when a microwave excitation signal is applied to the electrode;

a winding electrically coupled to the electrode whereby the winding and the electrode form a radiofrequency resonating structure adapted to radiate a radiofrequency field into the combustion chamber when a radiofrequency excitation signal is applied to the winding; and a microwave signal path adapted to transfer the microwave excitation signal from a signal input connector on the ignition unit to the electrode, the microwave signal path comprising an inductive portion and a capacitive coupling structure adapted to provide a capacitive coupling from the inductive portion to the electrode.

In such an ignition unit, the inductive portion and the capacitive coupling structure of the microwave signal path allow efficient transfer of microwave energy to the electrode and, thus, to the microwave resonating structure. That is, the microwave signal path may transfer a microwave excitation signal, which is applied to the microwave signal connector, to the microwave resonating structure with relatively little loss.

In accordance with a further aspect of the invention as defined in claim 15, there is provided a motorized product comprising a combustion engine on which an ignition unit has been fitted.

For the purpose of illustration, some embodiments of the invention are described in detail with reference to accompanying drawings. In this description, additional features will be presented and advantages will be apparent.

### BRIEF DESCRIPTION OF THE DRAWINGS

FIG. 1 is a cross-sectional diagram of a first embodiment of an ignition unit.

FIG. 2 is a cross-sectional diagram of a second embodiment of an ignition unit.

FIG. 3 is a cross-sectional diagram of an insulating member in the second embodiment of the ignition unit, wherein geometry values are indicated.

FIG. 4 is a simplified cross-sectional diagram of a first embodiment of a front section of an ignition unit.

FIG. 5 is a simplified cross-sectional diagram of a second embodiment of a front section of an ignition unit.

FIG. 6 is a simplified cross-sectional diagram of a third embodiment of a front section of an ignition unit.

FIG. 7 is a cross-sectional diagram of a third embodiment of an ignition unit.

FIG. 8 is a block diagram of a motorized product comprising a combustion engine on which an ignition unit has been fitted.

### DESCRIPTION OF EMBODIMENTS OF THE INVENTION

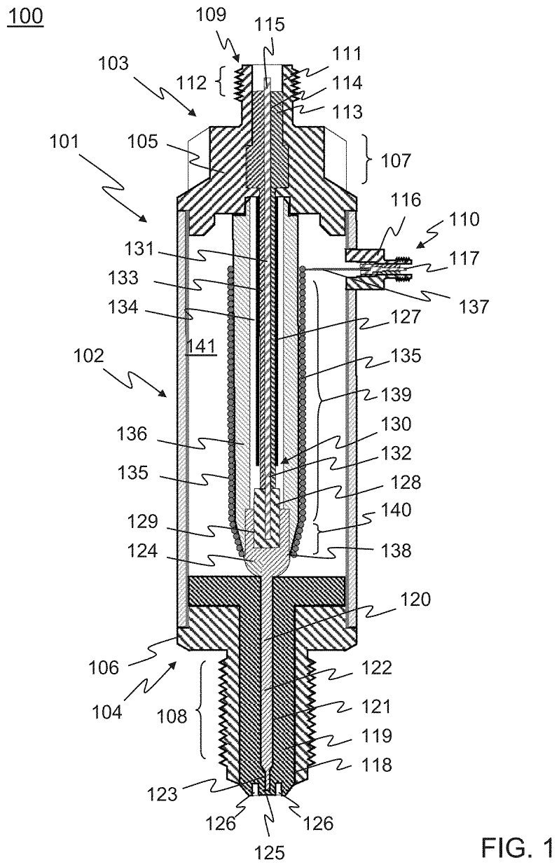

FIG. 1 schematically illustrates a first embodiment of an ignition unit 100, which will hereinafter be referred to as first ignition unit 100 for the sake of convenience. FIG. 1 provides a cross-sectional diagram of the first ignition unit 100. The first ignition unit 100 may be adapted, for example, to be fitted in a combustion engine as if this unit were a conventional sparkplug. The first ignition unit 100 may also be applied to, for example, turbine engines.

The first ignition unit 100 comprises a housing 101, which may at least partially be formed of conductive material, such as, for example, metal. Steel, for example, is a suitable metal. The housing 101 comprises a cylindrical tube 102 and two end plugs 103, 104, an input end plug 103 and an output end plug 104. The input end plug 103 comprises a shell body 105, which will hereinafter be referred to as input plug shell body 105. The output end plug 104 also comprises a shell body 106, which will hereinafter be referred to as output plug shell body 106.

The cylindrical tube 102 may be in the form of a steel tube that has an inner surface with silver (Ag) plating. The cylindrical tube 102 has an inner diameter, which may be comprised in a range between, for example, 15 mm and 21 mm. The two aforementioned shell bodies 105, 106 of the end plugs 103, 104 may also be formed of steel. The input plug shell body 105 may be fixed to the cylindrical tube 102 by means of, for example, laser welding. The output plug shell body 106 may also be fixed to the cylindrical tube 102 in this manner.

The input plug shell body 105 comprises a section 107 with a hexagonal circumference. A wrench may engage with this section 107 for screwing the first ignition unit 100 into a threaded opening in a combustion engine. The output plug shell body 106 comprises a section 108 with a spirally threaded circumference, which may engage with a threaded opening in a combustion engine. This section 108 of the output plug shell body 106 may have, for example, one of the following thread sizes, which are used for conventional sparkplugs: M12, M14, and M18. The first ignition unit 100 may thus replace a conventional sparkplug.

The first ignition unit 100 comprises two signal connectors: a microwave signal connector 109 and a radiofrequency signal connector 110. The microwave signal connector 109 is incorporated in the input end plug 103. The radiofrequency signal connector 110 is mounted in the cylindrical tube 10 of the housing 101. The microwave signal connector 109 may be, for example, of the N-type or the HN-type. The radiofrequency signal connector 110 may be, for example, of the SMA type. The housing 101 of the first ignition unit 100 may constitute signal ground.

In more detail, the microwave signal connector 109 is formed by a central bore 111 in the input plug shell body 105. The input plug shell body 105 has a spirally threaded section 112 that partially extends over this central bore 111. The spirally threaded section 112 constitutes a signal ground connector. A cylindrical insulator 113 is fitted in the central bore 111. The cylindrical insulator 113 comprises a central bore in which a core conductor 114 is fitted. An end portion 115 of the core conductor 114 protrudes outwardly from the cylindrical insulator 113. This outwardly protruding end portion 115 constitutes a signal coupling end of the microwave signal connector 109.

The radiofrequency signal connector 110 comprises a support 116 that is mounted in the cylindrical tube 102 of the housing 101. The support 116 may constitute signal ground. The support comprises a bore in which a cylindrical insulator is fitted. Like in the microwave signal connector 109, the cylindrical insulator comprises a central bore in which a conductive pin 117 is fitted. An end portion of the conductive pin 117 precludes outwardly from the cylindrical insulator. This outwardly protruding end portion constitutes a signal coupling end of the radiofrequency signal connector 110.

The output plug shell body 106 comprises a central bore 118 in which an insulating member 119 is fitted. The insulating member 119 is preferably tightly fit in the central bore 118 so as to avoid air gaps between the insulating member 119 and the output end plug 104. The insulating member 119 may be of ceramic material, such as, for example, aluminum nitride, polyether ether ketone (PEEK), or polytetrafluoroethylene (PTFE). Alternatively, the insulating member 119 may comprise quartz glass, which exhibits relatively low dielectric loss.

In the output end plug 104, an electrode 120 is fitted in a central bore 121 of the insulating member 119. The electrode 120 may also be formed of conductive material, such as, for example, an Inconel™ type alloy, Inconel being a trademark of Special Metals Corporation. Inconel 600 could be an appropriate choice. As another example, nickel or Kovar could also be appropriate choices, Kovar being a registered trademark of CRS Holdings, Inc., a subsidiary of Carpenter Technology Corp. (US). Any of these materials may be copper-plated or silver-plated for good electric conductivity at microwave frequencies. The electrode 120 may be hollow, at least partially, to reduce thermally induced mechanical stress due to differences in coefficients of thermal expansion.

The electrode 120 has a main section 122, a tip section 123, and a cap-like section 124. The main section 122 and the tip section 123 are embedded in the insulating member 119. The tip section 123 of the electrode 120 may be exposed to a combustion chamber when the ignition unit 100 is fitted on a combustion engine. A tip section 125 of the insulating member 119 may the also be exposed to the combustion chamber. The cap-like section 124 protrudes inwardly from the insulating member 119 into the cylindrical tube 102. The cap-like section 124 has a convex surface curving towards the main section 122 of the electrode 120, as illustrated in FIG. 1. The cap-like section 124 may have, for example, a hemispherical shape

The main section 122 of the electrode 120 has a diameter that may be comprised in a range between, for example, 1.5 and 3.5 mm. The tip section 123 of the electrode 120 may have a smaller diameter, as illustrated in FIG. 1. The tip section 123 may have a diameter comprised between, for example, 0.3 mm and 1.0 mm. The main section 122 and the tip section 123 of the electrode 120 may be embedded in the insulating member 119 by, for example, press fitting. There may be an interface between these sections of the electrode 120 and the insulating member 119. This interface may comprise, for example, glue, glass, or a metallic bond obtained by brazing for example.

The electrode 120, the insulating member 119, and the output plug shell body 106 jointly form a microwave resonating structure. The microwave resonating structure has a primary resonance frequency that may be comprised in a range between, for example, 1 GHz and 10 GHz. More specifically, the primary resonance frequency may be, for example, 2.45 GHz, which is a typical operating frequency of a microwave oven.

The microwave resonating structure may have an impedance at the primary resonance frequency that may be comprised in a range between, for example, 20Ω and 40Ω. The impedance is substantially determined by a relative permittivity of a material, or a set of materials, that form the insulating member 119. For example, the relative permittivity of plastic materials is approximately 2, whereas that of silicon nitride is approximately 7.5, that of boron nitride (BN) is approximately 4, and that of aluminum nitride approximately 8.5.

Another characteristic of the microwave resonating structure that may be taken into consideration concerns transmission loss, in particular at the primary resonance frequency, which may be, for example, approximately 2.45 GHz. The transmission loss may be approximated as proportional to √(tan δ)·εr where tan δ is the dissipation factor of the insulating member 119, or rather that of the material it is made of, and εr is the relative permittivity. This approximation allows materials to be quickly compared. In order of preference, materials for the insulating member 119 may include: fused quartz, silica, polyethylene (PE), PTFE, BN, Sapphire, and beryllium oxide (BeO). However, regarding choice of materials, other characteristics may also be taken into consideration, such as, for example, maximum operating temperature, and thermal conductivity

The insulating member 119 may have a length that can be expressed as (2N+1)/4λ, wherein λ, represents a wavelength corresponding with the primary resonance frequency of the insulating member 119, and wherein N represents an integer. The length of the insulating member 119 may thus be, for example, ¾λ.

The tip section 125 of the insulating member 119 may have a specific shape that causes the tip section 125 to behave like a microwave lens. The tip section 125 will then bundle a microwave field that is radiated outwardly from the microwave resonator. In this embodiment, the tip section 125 has an annular groove 126, which provides such a microwave field bundling effect.

A microwave signal path in the first ignition unit 100 allows transferring a microwave excitation signal from the microwave signal connector 109 to the electrode 120 and, thereby, to the microwave resonating structure mentioned hereinbefore. In this embodiment, the microwave signal path includes a coaxial transmission line 127 and a coaxial cylinder of dielectric material 128. The coaxial cylinder of dielectric material 128 is fitted in a central bore 129 of the cap-like section 124 of the electrode 120. The coaxial transmission line 127 may be in the form of, for example, a semi-rigid coaxial cable. The semi-rigid coaxial cable may be, for example, of the type RG401. The coaxial cylinder of dielectric material 128 may comprise, for example, PTFE plastic or aluminum nitride ceramic material, such as, for example, the material commercialized under the name “Shapal®”, which is a registered trademark of Tokuyama Corporation (Japan). Other ceramic materials may also be used and even provide better performance.

In more detail, the coaxial transmission line 127 extends from the microwave signal connector 109 to a point 130 somewhat before the coaxial cylinder of dielectric material 128. The coaxial transmission line 127 has a core conductor 131, which may correspond with the core conductor 114 in the microwave signal connector 109 described hereinbefore. The core conductor 131 protrudes from the point 130 where the coaxial transmission line 127 ends into a central bore in the coaxial cylinder of dielectric material 128. This protruding portion 132 of the core conductor 131 constitutes an inductive portion of the microwave signal path. The protruding portion 132, the coaxial cylinder of dielectric material 128, and the cap-like section 124 of the electrode 120 with its central bore jointly constitute a capacitive coupling structure in the microwave signal path.

The inductive portion and the capacitive coupling structure of the microwave signal path allow efficient transfer of microwave energy to the electrode 120 and, thus, to the microwave resonating structure. That is, the microwave signal path may transfer a microwave excitation signal, which is applied to the microwave signal connector 109, to the microwave resonating structure with relatively little loss. In this embodiment, the microwave energy is capacitively coupled from the point 130 where the coaxial transmission line 127 ends, through the coaxial cylinder of dielectric material 128, to the cap-like portion of the electrode 120 and thus to the microwave resonating structure.

To prevent corona formation, minimum clearance is desired between the protruding portion 132 of the core conductor 114 and the central bore in the coaxial cylinder of dielectric material 128. For the same reason, minimum clearance is also desired between the coaxial cylinder of dielectric material 128 and the central bore 129 in the cap-like section 124 of the electrode 120. Any gap may be eliminated, for example, by gluing or by filling the gap with dielectric grease.

In an experimental implementation of the first ignition unit 100, the coaxial transmission line 127 was in the form of a RG401 coaxial cable, comprising a PTFE insulator 133 between the core conductor 131 and a conductive shield 134 enveloping the PTFE insulator 133. In the experimental implementation, the microwave excitation signal had a wavelength in the RG401 coaxial cable of λ_{PTFE}≈81 mm.

Favorable results were obtained with the following characteristics. The conductive shield 134 of the RG401 coaxial cable had a length of approximately 3λ_{PTFE}/2. The length of the conductive shield 134 of the RG401 coaxial cable was found to be critical for efficient transfer of microwave energy. An intermediate section with the PTFE insulator 133 exposed extended from the point 130 where the conductive shield 134 ended to the coaxial cylinder of dielectric material 128 in the central bore 129 of the cap-like section 124 of the electrode 120. This intermediate section had a length of approximately 9.5 mm. This length prevented arcing. The protruding portion 132 of core conductor 131, from the point 130 where the conductive shield 134 ended to an end in the central bore in the coaxial cylinder of dielectric material 128, had a length of approximately 20.5 mm.

Furthermore, in the experimental implementation, there was a ratio of approximately 3.26 between, on the one hand, a diameter of the core conductor 131 in the central bore in the coaxial cylinder of dielectric material 128 and, on the other hand, a diameter of the central bore 129 in the cap-like portion of the electrode 120. This ratio corresponded to a ratio of an inner diameter and an outer diameter of the PTFE insulator 133 in the RG401 coaxial cable. Accordingly, the microwave signal connector 109 presented an effective input impedance that was close to a desired impedance value, namely 50Ω. The protruding portion 132 of the core conductor 131 that was within the coaxial cylinder of dielectric material 128 had a length of approximately 5.5 mm. This length presented a peak in microwave energy transfer efficiency. The aforementioned capacitive coupling structure formed by the aforementioned elements had a capacitance of approximately 1.9 pF.

Furthermore, in the experimental implementation, the diameter of the main section 122 of the electrode 120 was 3.0 mm. The electrode 120 had an overall length of approximately 80 mm from the cap-like section 124 to the tip section 123. This length, only slightly smaller than PTFE, provided optimum results. The length of the electrode 120 was found to be critical in the experimental implementation. It was observed that deviating from this length substantially diminished the interaction of microwave energy and the radio frequency energy at the tip section 123, resulting in a smaller plasma expansion. The insulating member 119 had a length of approximately 66 mm. This length was found to be optimum. However, a different length may be optimum in case the electrode 120 has a different geometry.

A radiofrequency signal path in the first ignition unit 100 allows transferring a radiofrequency excitation signal from the radiofrequency signal connector 110 to the electrode 120 and, more specifically, to the tip section 123 of the electrode 120. In this embodiment, the radiofrequency signal path includes a winding on a winding support 136 and a conductive wire 137 that extends from the radiofrequency signal connector 110 to an input end of the winding 135. This conductive wire 137 is electrically coupled with the conductive pin 117 in the radiofrequency signal connector 110 mentioned hereinbefore. The winding 135 has an output end 138 that is electrically coupled to the cap-like section 124 of the electrode 120. The winding 135 may be formed of a wire of conductive material, such as, for example, copper. The wire may be insulated with, for example a dielectric varnish typical of transformer winding wire. The winding support 136 may be formed of, for example, PTFE plastic or dielectric materials with relatively low permittivity, such as, for example ceramic materials.

The winding 135, the electrode 120, and the housing 101 jointly form a radiofrequency resonator. The winding 135 and the electrode 120 constitute an inductive portion of the radiofrequency resonator. A capacitive coupling between, on the one hand, the winding 135 and the electrode 120 and, on the other hand, the housing 101, constitutes a capacitive portion of the radiofrequency resonator. The radiofrequency resonator has a primary resonance frequency that may be comprised in a range between, for example, 1 Megahertz (MHz) and 10 MHz. More specifically, the primary resonance frequency may be, for example, 4 MHz. The radiofrequency resonator may have an impedance at the primary resonance frequency that may be comprised in a range between, for example, 2 kΩ and 3.5 kΩ.

In more detail, the winding 135 has a main section 139 of substantially constant outer diameter. This outer diameter may be comprised in a range between, for example, 15 mm and 20 mm, 17.5 mm being a suitable value for the outer diameter. Such an outer diameter allows accommodating passage of the coaxial transmission line 127 through an inner space of the winding 135 is illustrated in FIG. 1. The passage of the coaxial transmission line 127 may cause parasitic capacitive losses. These losses are essentially due to a capacitive coupling between on the one hand, the winding 135 and, on the other hand, the conductive shield 134 of the coaxial transmission line 127, through the winding support 136. Forming the winding support 136 of PTFE plastic as mentioned hereinbefore contributes to reducing the parasitic capacitive losses. In this respect, it may also be preferable that the winding support 136 has an even outer surface, without a helical winding 135 groove.

The winding 135 has a tapered end section 140 that extends from the main section 139 to the output end 138 of the winding 135. At the output end 138 of the winding 135, the outer diameter of the winding 135 may reduce to a value comprised in a range between 0.2 and 0.5 times the inner diameter of the cylindrical tube 102 surrounding the winding 135. For example, the ratio may reduce to 0.368 the output end 138. The tapered end section 140 of the winding 135 helps to prevent internal flashover that could occur at the output end 138 of the winding 135.

The winding 135 may have a length so that the radiofrequency resonator has a desired primary resonance frequency, which may be, for example, 4 MHz. For example, the capacitive portion of the radiofrequency resonator may be, for example, approximately 28 Picofarad (pF). As mentioned hereinbefore, the capacitive portion is essentially defined by the capacitive coupling between the winding 135 and the electrode 120, on the one hand, and the housing 101, on the other hand. In case the desired primary resonance frequency is approximately 4 MHz, the winding 135 may have a length so that the winding 135 has an inductance of, for example, 120 Microhenry (μH).

The cylindrical tube 102 may be filled with pressurized gas 141. The pressurized gas 141 may constitute a dielectric medium. The pressurized gas 141 may be, for example, pressurized air or pressurized nitrogen (N2). The pressurized gas 141 may provide a pressure of, for example, 20 bar inside the cylindrical tube 102. In case a dielectric coating on the winding 135 is absent, a higher pressure may be required to prevent internal flashover, or a more dielectric gas, such as, for example, sulfur hexafluoride (SF6) may also be used.

A relatively high pressure in the cylindrical tube 102, or a specific pressurized gas, or both, may also be required to prevent internal flashover if a high voltage radiofrequency excitation signal is transferred. A high voltage radiofrequency excitation signal is typically required to create radiofrequency discharges in a combustion chamber where pressures are relatively high. Thus, in general, the pressure in the cylindrical tube may be related to a combustion chamber pressure.

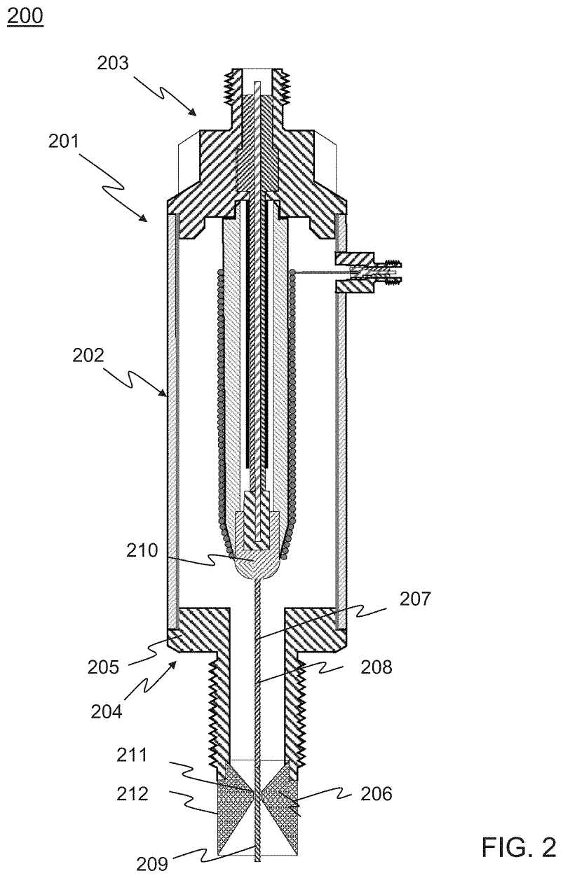

FIG. 2 schematically illustrates a second embodiment 200 of an ignition unit, which will hereinafter be referred to as second ignition unit 200 for the sake of convenience. FIG. 2 provides a cross-sectional diagram of the second ignition unit 200. The second ignition unit 200 may be regarded as an adaptation of the first ignition unit. This adaptation may be made to better suit a particular type of combustion engine. For example, in a turbine engine an ignition unit may need to be able to withstand combustion temperatures of approximately 2000° C. for a relatively long period of time. For example, in a turbine engine, the ignition unit may be functional for a relatively short time only during the starting operation of the turbine engine, after which the ignition unit remains continuously exposed to combustion gas once the turbine engine is running, which may be for a period of several hours.

Like the first ignition unit 100, the second ignition unit 200 comprises a housing 201 that includes a cylindrical tube 202 and two end plugs 203, 204: an input end plug 203 and an output end plug 204. The cylindrical tube 202 and the input end plug 203 may be similar to those of the first ignition unit 100. These entities will therefore not be discussed in greater detail for the sake of conciseness. The output end plug 204 of the second ignition unit 200 is different from that of the first ignition unit 100. Differences may reside in structure as well as in materials used. In this embodiment, the output end plug 204 comprises a shell body 205 that is nonetheless similar to that of the first ignition unit 100. The shell body 205 will hereinafter be referred to as output plug shell body 205. However, other elements of the output end plug 204 are different from those of the output end plug 104 in the first ignition unit 100.

The output end plug 204 comprises an insulating member 206 that is fitted on an end of the output plug shell body 205. The insulating member 206 protrudes outwardly from the end of the output plug shell body 205. The insulating member 206 may comprise, for example, ceramic material, preferably ceramic material that has a relatively good high frequency transmission capability and relatively good formability, while being relatively inexpensive. Examples of such ceramic materials include, for example, quartz and Shapal® mentioned hereinbefore.

An electrode 207 coaxially traverses the insulating member 206. The electrode 207 has a main section 208, a tip section 209, and a cap-like section 210. The tip section 209 tip protrudes from the insulating member 206. The tip section 209 has a length that may be critical with regard to radiofrequency surface discharge and good projection of this discharge in the form of a branched streamer structure. The length of the tip section 209 may be, for example, at least 1 mm. In a practical implementation in which the length of the tip section 209 was approximately 2.5 mm allowed achieving favorable results.

The tip section 209 may comprise refractory conductive material, such as, for example, a platinum alloy. The main section 208 and the cap-like section 210 may comprise another conductive material, such as, for example, copper. The tip section 209 may be welded to the main section 208 by means of, for example, pressure welding, laser welding, electron beam welding, or another suitable welding technique. In order facilitate welding; the tip section 209 and the main section 208 of the electrode 207 may have a relatively small diameter, for example, in the range comprised between 0.5 mm and 1.0 mm, or, more specifically between 0.6 mm and 0.8 mm. A relatively small diameter may also contribute to achieving that any microwave signal losses are relatively small.

Ideally, there should be no air gap between the insulating member 206 and the electrode 207. An air gap may cause corona formation, which may result in poor performance. In order to avoid air gaps, dielectric grease or glue, for example, may be applied between the electrode 207 and the insulting member.

The insulating member 206 has an inner surface 211 that surrounds (is essentially flush with) the electrode 207. The inner surface 211 is smaller than an outer surface 212 of the insulating member 206. That is, the inner surface 211 of the insulating member 206, which is flush with the electrode 207, is relatively small. This contributes to achieving that any microwave signal losses in the output end plug 204 are relatively small.

In this embodiment, the insulating member 206 has a cross section that is V-shaped between the outer surface 212 and the inner surface 211, pointing towards the inner surface 211, as illustrated in FIG. 2. That is, the insulating member 206 has a cross-sectional double mirrored V-shape. This shape contributes to avoiding radiofrequency surface discharge. Moreover, the cross-sectional double mirrored V-shape allows suitable impedance adaptation for a microwave excitation signal that reaches the electrode 207. This in turn allows achieving relatively high transmission efficiency so that any microwave signal losses are relatively small.

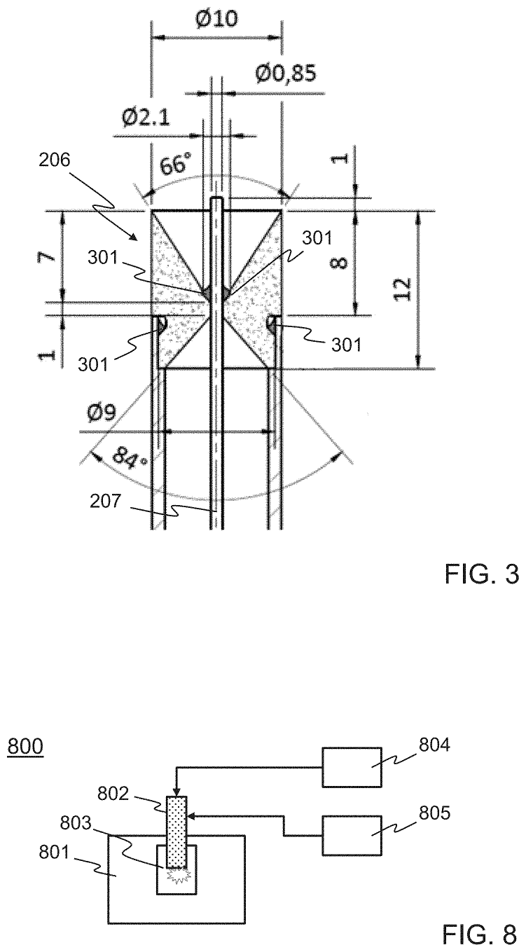

FIG. 3 illustrates a practical implementation 300 of the insulating member 206 and indicates geometry values that allowed achieving favorable results. In FIG. 3, geometry values relating to distances and diameters are expressed in millimeters. Geometry values relating to angles are expressed in degrees.

The practical implementation illustrated in FIG. 3 comprises brazed joints 301 between the electrode 207 and the insulating member 206. The brazed joints 301 avoid air gaps between the aforementioned elements. Moreover, the brazed joints 301 allow satisfactory evacuation of heat from the tip section 209 of the electrode 207 tip. In addition, the brazed joints 301 form a seal between an interior of the second ignition unit 200, which may be filled with pressurized gas as mentioned hereinbefore in connection with the first ignition unit 100.

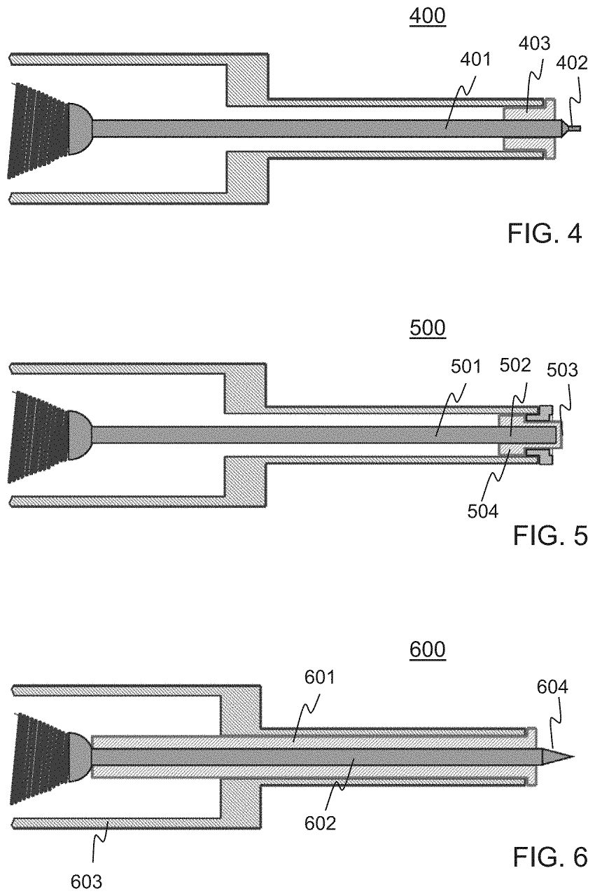

FIGS. 4, 5, and 6 illustrate various embodiments of a front section of an ignition unit. FIGS. 4, 5, and 6 each provide a simplified cross-sectional diagram of the embodiment concerned of the front section of an ignition unit. Like the first and the second ignition unit 200s described hereinbefore, each embodiment comprises an electrode 207 and an insulating member 206 in which the electrode 207 is fitted. The electrode 207 and the insulating member 206 of each embodiment are different from those of the other embodiments. Each embodiment further comprises a housing 201 that is partially represented in a simplified manner. For the sake of simplicity, no distinction is made between a cylindrical tube 202 and an output end plug 204 in FIGS. 4, 5, and 6.

FIG. 4 illustrates a first embodiment 400 in which the electrode 401 has a tip section 402 that protrudes from the insulating member 403. The tip section 402 has a conical section and a relatively narrow end section. This shape of the tip section 402 ensures satisfactory electric field concentration allowing reliable radiofrequency discharge. This may be especially important when discharging into a high pressure combustion chamber. The insulating member 403 is relatively short, occupying a relatively small portion only of a bore in an output plug shell body.

FIG. 5 illustrates a second embodiment 500 in which the electrode 501 has a tip section 502 that is shielded off by a front portion 503 of the insulating member 504. That is, the front portion 503 of the insulating member 504 constitutes a barrier that prevents the tip section 502 of the electrode 501 from being directly exposed to heat and combustion substances. In this embodiment too, the insulating member 504 is relatively short occupying a relatively small portion only of a bore in an output plug shell body.

FIG. 6 is a simplified cross-sectional diagram of a third embodiment 600 in which the insulating member 601 is relatively long and essentially encapsulates the electrode 602. This embodiment may be used in applications where combustion chamber pressures are relatively high. As explained hereinbefore, this may require a relatively high pressure within the cylindrical tube, which is designated by reference 603 in FIG. 6. In general it holds that the longer the insulating member 601 is, the better the insulating member 601 may withstand high pressures. In this embodiment, the electrode 602 has a pointed tip section 604 that protrudes from the insulating member 601.

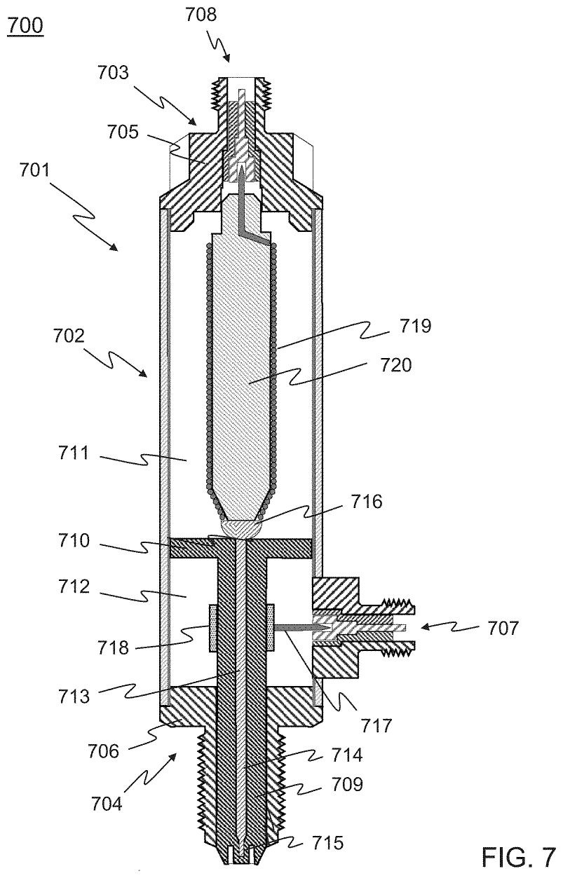

FIG. 7 schematically illustrates a third embodiment 700 of an ignition unit, which will hereinafter be referred to as third ignition unit 700 for the sake of convenience. FIG. 7 provides a cross-sectional diagram of the third ignition unit 700. Compared with the first ignition unit 100, the third ignition unit 700 comprises a different microwave signal path for internally transferring a microwave excitation signal that is applied to the third ignition unit 700.

Like the first ignition unit 100, the third ignition unit 700 comprises a housing 701 that includes a cylindrical tube 702 and two end plugs 703, 704: an input end plug 703 and an output end plug 704. The input end plug 703 comprises a shell body 705, which will hereinafter be referred to as input plug shell body 705. The output end plug 704 also comprises a shell body 706, which will hereinafter be referred to as output plug shell body 706. The cylindrical tube 702 may comprise materials and may have dimensions similar to those mentioned hereinbefore with respect to the cylindrical tube 102 of the first ignition unit 100. The input plug shell body 705 may have an outer shape similar to that of the first ignition unit 100 so that the third ignition unit 700 may conveniently be filled on a combustion engine. The output plug shell body 706 may also have an outer shape similar to that of the first ignition unit 100 for the same purpose.

Like the first ignition unit 100, the third ignition unit 700 comprises a microwave signal connector 707 and a radiofrequency signal connector 708. However, these connectors 707, 708 are located differently. In the third ignition unit 700, the microwave signal connector 707 is mounted on the cylindrical tube 702 of the housing 701, whereas the radiofrequency signal connector 708 in incorporated in the input end plug 703. The microwave signal connector 707 is located relatively close to the output end plug 704. The microwave signal connector 707 may be, for example, of the N type. The microwave signal connector 707 may have a basic structure similar to that of the radiofrequency signal connector 708 of the first ignition unit 100 discussed hereinbefore, notwithstanding that these aforementioned connectors may be of a different type. The radiofrequency connector may be, for example, of the SMA type. The radiofrequency signal connector 708 may be embedded in the input end plug 703 in a manner similar to that in which the radiofrequency signal connector 708 in the input end plug 703 of the first ignition unit 100 discussed hereinbefore.

Like in the first ignition unit 100, the output plug shell body 706 comprises a central bore in which an insulating member 709 is fitted, preferably tightly. The insulating member 709 extends into the cylindrical tube 702. The insulating member 709 comprises a flange-like portion 710 that circumferentially touches the cylindrical tube 702. In effect, the flange-like portion 710 defines two interior chambers 711, 712 within the cylindrical tube 702: a main chamber 711 and a downstream chamber 712. Both these chambers 711, 712 may be filled with pressurized gas, as mentioned hereinbefore with respect to the first ignition unit 100.

Like in the first ignition unit 100, an electrode 713 is fitted in a central bore of the insulating member 709. The electrode 713 may have an overall length of, for example, 3λ_{IM}/2, kw being the wavelength of the microwave excitation signal in the insulation member. Like in the first ignition unit 100, the electrode 713, the insulating member 709, and the output plug shell body 706 jointly form a microwave resonating structure. This microwave resonating structure too may have a primary resonance frequency comprised in a range between, for example, 1 GHz and 10 GHz.

The electrode 713 has a main section 714, a tip section 715, and a cap-like section 716. The main section 714 and the tip section 715 are embedded in the insulating member 709. The tip section 715 may have a sharp end such as, for example, a tapered reduction of diameter from 3 mm to 0.8 mm with a 60° included angle cone. Such a sharp end allows good branching discharge at low applied voltage. Moreover, it was found that a sharp end did not significantly adversely affect microwave signal transmission. The cap-like section 716 protrudes inwardly from the flange-like portion 710 of the insulating member 709 into the main chamber 711 of the cylindrical tube 702. The cap-like section 716 may have a shape similar to that of the electrode 713 in the first ignition unit 100. In general, the electrode 713 in the third ignition unit 700 may comprise materials similar to those of the electrode 713 in the first ignition unit 100 mentioned hereinbefore.

A microwave signal path in the third ignition unit 700 allows transferring a microwave excitation signal from the microwave signal connector 707 to the electrode 713 and, thereby, to the microwave resonating structure mentioned hereinbefore. In this embodiment, the microwave signal path includes a conductive pin 717 and a conductive ring 718 that surrounds a portion of the insulating member 709 in the downstream chamber 712. In the third ignition unit 700, the conductive pin 717, which extends from the microwave signal connector 707 to the conductive ring 718, constitutes an inductive portion of the microwave signal path. The conductive ring 718 that surrounds a portion of the insulating member 709, and thus a portion of the main section 714 of the electrode 713, constitutes a capacitive portion of the microwave signal path.

The inductive portion and the capacitive coupling structure of the microwave signal path allow efficient transfer of microwave energy to the microwave resonating structure. That is, the microwave signal path may transfer a microwave excitation signal, which is applied to the microwave signal connector 707, to the microwave resonating structure with relatively little loss. In this embodiment, the microwave energy is capacitively coupled from a point where the conductive pin 717 is coupled to the conductive ring 718, through the conductive ring 718 and the portion of the insulating member 709 surrounded by the conductive ring 718, to the main section 714 of the electrode 713 and thus to the microwave resonating structure.

In a practical implementation, the conductive pin 717 had a length of approximately 15 mm, which was found to provide optimum performance in this implementation. Generally, it was found that transfer of microwave energy from the microwave signal connector 707 to the microwave resonating structure had an efficiency that depended on the length of the conductive pin 717. Moreover, it was also found that the length at which efficiency is optimum is also the length at which performance of the third ignition unit 700 is substantially independent of a cable length between a microwave signal source and the microwave signal connector 707. Thus, in a different practical implementation of the third ignition unit 700, an optimum length of the conductive pin 717 may be found, which may be different from 15 mm.

In the practical implementation mentioned hereinbefore, the electrode 713 had a diameter of approximately 3 mm, whereas the conductive ring 718 had an inside diameter that was 2.8 times larger. This ratio of 2.8 provided optimum microwave signal transfer efficiency. The conductive ring 718 had an axial length of approximately 5 mm, which was found to be optimum. However, microwave signal transfer efficiency was found to be relatively insensitive to the axial length of the conductive ring 718, which may lie within a range comprised between, for example, 1 mm and 30 mm. The conductive ring 718 had an outside diameter of approximately 11 mm. The cylindrical tube 702 surrounding the conductive ring 718 had been inside diameter that was approximately 1.9 times larger. This ratio of 1.9 provided optimum results. However, satisfactory results may be achieved with a different ratio. It was found that performance was relatively insensitive to the ratio between the inside diameter of the cylindrical tube 702 and the outside diameter of the conductive ring 718.

A radiofrequency signal path in the third ignition unit 700 allows transferring a radiofrequency excitation signal from the radiofrequency signal connector 708 to the electrode 713 and, more specifically, to the tip section 715 of the electrode 713. Like in the first ignition unit 100, the radiofrequency signal path includes a winding 719 on a winding support 720. In this embodiment, the winding 719 essentially extends from the radiofrequency signal connector 708, which is embedded in the input end plug 703 to the cap-like section 716 of the electrode 713. The winding 719 and the winding support 720 may be similar to those in the first ignition unit 100 discussed hereinbefore.

FIG. 8 schematically illustrates a motorized product 800 comprising a combustion engine 801 on which an ignition unit 802 has been fitted. The ignition unit can produce an ignition in a combustion chamber 803 of the combustion engine. FIG. 8 provides a block diagram of the motorized product 800. The ignition unit 802 may be any one of the embodiments described hereinbefore, or any alternative thereof. The motorized product 800 comprises a microwave signal source 804 and a radiofrequency signal source 805 adapted to apply a microwave excitation signal and a radiofrequency excitation signal, respectively, to the ignition unit 802. The description in patent publication WO 2016/012448 with regard to generating such signals and applying these to an ignition unit may equally apply to the motorized product 800 illustrated in FIG. 8.

The embodiments described hereinbefore with reference to the drawings are presented by way of illustration. The invention may be implemented in numerous different ways. In order to illustrate this, some alternatives are briefly indicated.

The invention may be applied in numerous types of products or methods related to producing an ignition in a combustion chamber. For example, the invention may be applied in any type of positively ignited engine. Such an engine may be, for example, a racing engine, an automotive engine for a car, a motorcycle, a truck, and so on, a large transport engine for railway transportation, a stationary engine used for, for example, electrical power generation, or a continuous combustion engine, in particular gas and liquid-fueled turbines for aircraft or other use.

In general, there are numerous different ways of implementing the invention, whereby different implementations may have different topologies. In any given topology, a single entity may carry out several functions, or several entities may jointly carry out a single function. In this respect, the drawings are very diagrammatic.

There are numerous ways of storing and distributing a set of instructions, that is, software, which allows a video encoder to operate in accordance with the invention. For example, software may be stored in a suitable device readable medium, such as, for example, a memory circuit, a magnetic disk, or an optical disk. A device readable medium in which software is stored may be supplied as an individual product or together with another product, which may execute the software. Such a medium may also be part of a product that enables software to be executed. Software may also be distributed via communication networks, which may be wired, wireless, or hybrid. For example, software may be distributed via the Internet. Software may be made available for download by means of a server. Downloading may be subject to a payment.

The remarks made hereinbefore demonstrate that the embodiments described with reference to the drawings illustrate the invention, rather than limit the invention. The invention can be implemented in numerous alternative ways that are within the scope of the appended claims. All changes that come within the meaning and range of equivalency of the claims are to be embraced within their scope. Any reference sign in a claim should not be construed as limiting the claim. The verb “comprise” in a claim does not exclude the presence of other elements or other steps than those listed in the claim. The same applies to similar verbs such as “include” and “contain”. The mention of an element in singular in a claim pertaining to a product, does not exclude that the product may comprise a plurality of such elements. Likewise, the mention of a step in singular in a claim pertaining to a method does not exclude that the method may comprise a plurality of such steps. The mere fact that respective dependent claims define respective additional features, does not exclude combinations of additional features other than those reflected in the claims.

1. An ignition unit adapted to produce an ignition in a combustion chamber of a combustion engine, the ignition unit comprising:
an electrode that has a tip section adapted to be exposed to the combustion chamber when the ignition unit is fitted on the combustion engine, the electrode forming part of a microwave resonating structure adapted to radiate a microwave field into the combustion chamber when a microwave excitation signal is applied to the electrode;
a winding electrically coupled to the electrode whereby the winding and the electrode form part of a radiofrequency resonator adapted to radiate a radiofrequency field into the combustion chamber when a radiofrequency excitation signal is applied to the winding, the radiofrequency resonator having a primary resonance frequency comprised in a range between 1 MHz and 10 MHz; and
a microwave signal path adapted to transfer the microwave excitation signal from a signal input connector on the ignition unit to the electrode, the microwave signal path comprising an inductive portion and a capacitive coupling structure adapted to provide a capacitive coupling from the inductive portion to the electrode.

2. An ignition unit according to claim 1, wherein the capacitive coupling structure comprises an electrically conductive body having a cavity, the electrically conductive body being conductively coupled to the electrode, the inductive portion of the microwave signal path comprising an electrically conductive tip that extends into the cavity.

3. An ignition unit according to claim 2, wherein the microwave signal path comprises a coaxial transmission line coupled between the signal input connector and the electrically conductive tip that extends into the cavity.

4. An ignition unit according to claim 2, wherein a body of dielectric material is at least partially disposed in the cavity, the electrically conductive tip extending into the body of dielectric material.

5. An ignition unit according to claim 3, wherein the body of dielectric material dielectrically forms a continuity of an insulator in the coaxial transmission line by means of at least one of the following arrangements: the body of dielectric material is dielectrically in contact with the insulator in the coaxial transmission line, and a gap between the body of dielectric material and the insulator in the coaxial transmission line is filled with dielectric material.

6. An ignition unit according to claim 5, wherein the body of dielectric material has an inner diameter and an outer diameter that match an inner diameter and an outer diameter, respectively, of the insulator in the coaxial transmission line.

7. An ignition unit according to claim 5, wherein the body of dielectric material comprises at least one of the following materials: ceramic material and plastic material.

8. An ignition unit according to claim 3, wherein the winding is disposed on a hollow tube-like support of dielectric material, the coaxial transmission line being at least partially located in the hollow tube-like support.

9. An ignition unit according to claim 1, wherein the winding has a tapered end section near the electrode.

10. An ignition unit according to claim 1, wherein the ignition unit comprises an electrically insulating body through which the tip section of the electrode extends into the combustion chamber if the ignition unit is fitted on the combustion engine.

11. An ignition unit according to claim 10, wherein the electrically insulating body has an inner surface that surrounds the electrode, the inner surface being smaller than an outer surface of the electrically insulating body.

12. An ignition unit according to claim 10, wherein the electrically insulating body comprises ceramic material.

13. An ignition unit according to claim 1, wherein the tip section of the electrode comprises refractory conductive material.

14. An ignition unit according to claim 1, wherein the electrode has a diameter in comprised between 0.5 and 5.0 mm.

15. A motorized product comprising a combustion engine on which an ignition unit according to claim 1 has been fitted.
